(19) United States
(12) Patent Application Publication
(10) Pub. No.: US 2008/0209471 A1
(43) Pub. Date: Aug. 28, 2008

(54) PROGRAM TABLE DISPLAY DEVICE AND PROGRAM TABLE DISPLAY METHOD

(75) Inventor: Takahiro Kimura, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/032,349

(22) Filed: Feb. 15, 2008

(30) Foreign Application Priority Data
Feb. 28, 2007 (JP) 2007-050312

(51) Int. Cl. H04N 5/445

(52) U.S. Cl. 725/39

(57) ABSTRACT

According to one embodiment, in a case of displaying an electronic program table prepared based on program information so that the table can move on a screen, when it is requested that the displayed electronic program table be moved to display, on the screen, a portion corresponding to a date on which any program information is not distributed, it is notified that no program information is present.

### CROSS-REFERENCE TO RELATED APPLICATIONS

This application is based upon and claims the benefit of priority from Japanese Patent Application No. 2007-050312, filed Feb. 28, 2007, the entire contents of which are incorporated herein by reference.

### BACKGROUND

1. Field

One embodiment of the invention relates to a program table display device for preferable use in a digital television broadcasting reception device and the like, and a program table display method.

2. Description of the Related Art

As is well known, in recent years, digitalization of television broadcasting has been greatly advanced. For example, in Japan, not only satellite digital broadcasting such as broadcasting satellite (BS) digital broadcasting and 110 degree communication satellite (CS) digital broadcasting but also terrestrial digital broadcasting have been started.

In a digital broadcasting reception device which receives such digital television broadcasting, an electronic program table is prepared based on electronic program guide (EPG) information acquired from a broadcasting signal to display an image on a screen. A user can therefore select a desired program from the electronic program table having the displayed image to view the program or reserve the program to be recorded.

At present, in digital television broadcasting, the EPG information includes information from which the electronic program table of the next one week can be prepared with respect to a large number of channels to be broadcasted. In the case of radio broadcasting, the EPG information includes information from which the electronic program table of the next three days can be prepared with respect to channels to be broadcasted.

Therefore, in the digital broadcasting reception device, the whole electronic program table cannot simultaneously be displayed on a limited-size screen. Therefore, the electronic program table is partially switched to display it on the screen. In this case, it is important to efficiently display the table so that a user can easily see the table.

Jpn. Pat. Appln. KOKAI Publication No. 2001-8119 discloses a constitution in which pieces of program information in a plurality of information providing systems are integrated to prepare and display the electronic program table. When a cursor reaches a start edge or a terminal edge of a scroll region, scrolling of one program information list is automatically switched to scrolling of another program information list.

Furthermore, Jpn. Pat. Appln. KOKAI Publication No. 9-37181 discloses a constitution in which static images having reduced representative screens of programs are divided into categories to arrange and display the static images in the form of strips. When the cursor positioned at the static image of an edge portion of the strip-like arrangement is further instructed to move outwardly, the whole static image is scrolled along the strips so as to display the static image of another category.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram to schematically explain a digital television broadcasting reception device and one example of a network system constituted around the device according to one embodiment of this invention;

FIG. 2 is a block diagram to explain a main signal processing system of the digital television broadcasting reception device according to the same embodiment;

FIG. 3 is an appearance diagram to explain a remote controller of the digital television broadcasting reception device according to the same embodiment;

FIG. 4 is a diagram to explain one example of an electronic program table to be displayed in the digital television broadcasting reception device according to the same embodiment;

FIG. 5 is a diagram to explain a state in which a cursor is moved along the electronic program table displayed in the digital television broadcasting reception device according to the same embodiment;

FIG. 6 is a diagram to explain one example of a message displayed in the electronic program table displayed in the digital television broadcasting reception device according to the same embodiment;

FIG. 7 is a diagram to explain another example of a message displayed in the electronic program table displayed in the digital television broadcasting reception device according to the same embodiment;

FIG. 8 is a diagram to explain a another example of a message displayed in the electronic program table displayed in the digital television broadcasting reception device according to the same embodiment;

FIG. 9 is a flow chart to explain a main part of an operation in which the digital television broadcasting reception device displays the electronic program table, according to the same embodiment; and

FIG. 10 is a diagram to explain one example of a date designation switch screen displayed in the electronic program table displayed in the digital television broadcasting reception device according to the same embodiment.

### DETAILED DESCRIPTION

Various embodiments according to the invention will be described hereinafter with reference to the accompanying drawings. In general, according to one embodiment of the invention, in a case of displaying an electronic program table prepared based on program information so that the table can move on a screen, when it is requested that the displayed electronic program table be moved to display, on the screen, a portion corresponding to a date on which any program information is not distributed, it is notified that no program information is present.

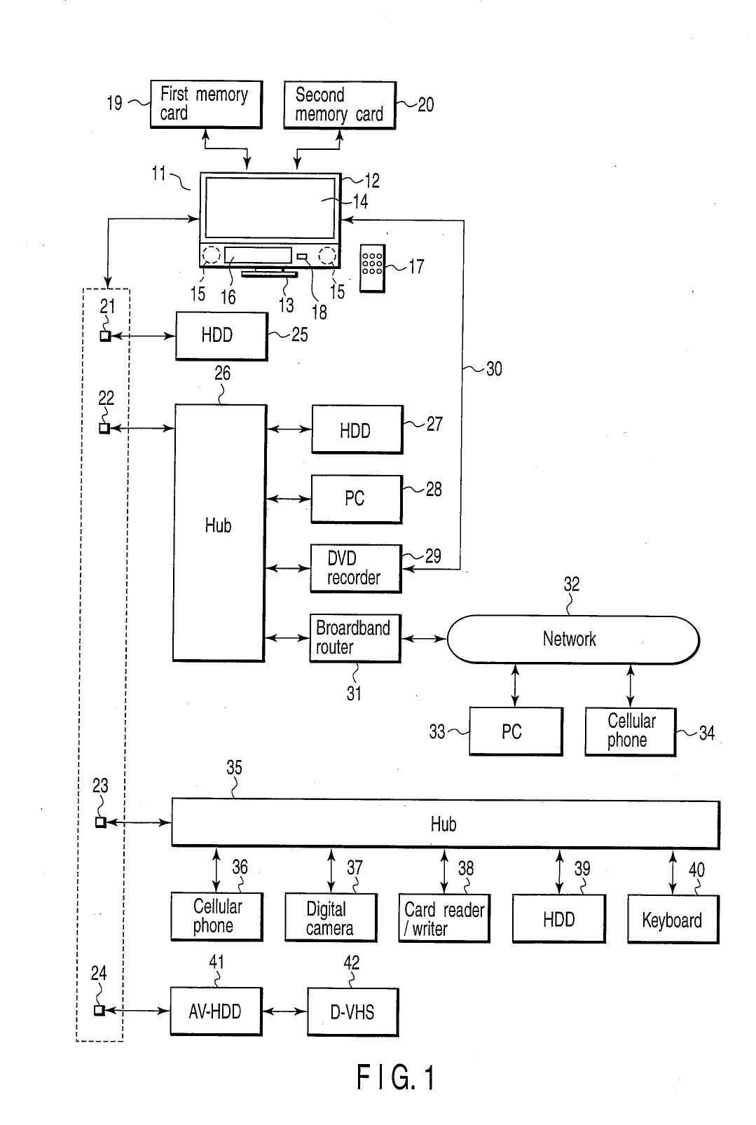

FIG. 1 schematically shows a digital television broadcasting reception device 11 which will be described in this embodiment, and which is one example of a network system constituted around this digital television broadcasting reception device 11.

That is, the digital television broadcasting reception device 11 mainly includes a thin cabinet 12, and a support base 13 which raises and supports the cabinet 12. Moreover, the cabinet 12 is provided with, for example, an image display unit 14 of a flat panel type including a liquid crystal display panel or the like, a pair of speakers 15, 15, an operating section 16, a light receiving section 18 which receives operating information transmitted from a remote controller 17, and the like.

This digital television broadcasting reception device 11 is detachably provided with, for example, a first memory card 19 such as a secure digital (SD) memory card, a multimedia card (MMC) or a memory stick, and this first memory card 19 permits recording and reproducing information such as a program and a photograph.

In addition, this digital television broadcasting reception device 11 is detachably provided with, for example, a second memory card [an integrated circuit (IC) card] 20 in which contract information or the like is recorded, and this second memory card 20 permits recording and reproducing predetermined information.

This digital television broadcasting reception device 11 includes four types of terminals for connection to external apparatuses, that is, a first local area network (LAN) terminal 21, a second LAN terminal 22, a universal serial bus (USB) terminal 23 and an i.Link terminal 24.

Among these terminals, the first LAN terminal 21 is used as a port for exclusive use in a hard disk drive (HDD) for a LAN, and the terminal is used to record and reproduce the information in and from an HDD 25 for LAN which is a connected network attached storage (NAS) via Ethernet (registered trademark).

As described above, the first LAN terminal 21 is disposed as the port for exclusive use in the HDD for LAN, whereby the information of the program can stably be recorded in the HDD 25 with a Hi-Vision image quality without being influenced by another network environment, network use situation or the like.

Moreover, the second LAN terminal 22 is used as a usual port for LAN using Ethernet (registered trademark), and connected to apparatuses such as an HDD 27 for LAN, a personal computer (PC) 28 and a digital versatile disk (DVD) recorder 29 containing an HDD therein via, for example, a hub 26 to transmit the information to these apparatuses.

It is to be noted that digital information to be transmitted to via the second LAN terminal 22 is information of an only control system, and hence an analog transmission path 30 for exclusive use has to be provided to the DVD recorder 29 for communication of analog image and voice information between the DVD recorder 29 and the digital television broadcasting reception device 11.

Furthermore, this second LAN terminal 22 is connected to a network 32 such as the Internet via a broadband router 31 connected to the hub 26, and used to perform communication of the information with respect to a PC 33, a cellular phone 34 and the like via the network 32.

In addition, the above USB terminal 23 is used as a usual USB port, and is connected to USB apparatuses such as a cellular phone 36, a digital camera 37, a card reader/writer 38 for a memory card, an HDD 39 and a keyboard 40 via, for example, a hub 35 to perform communication of the information with respect to these USB devices.

It is to be noted that instead of this USB terminal 23, a high definition multimedia interface (HDMI) terminal may be disposed so as to be connected to an external apparatus in conformity with the HDMI standard so that the information transmission is performed.

Moreover, the above i.Link terminal 24 is serially connected to, for example, an audio visual (AV)-HDD 41 and a digital (D)-video home system (VHS) 42, and used to perform the information transmission with respect to these apparatuses.

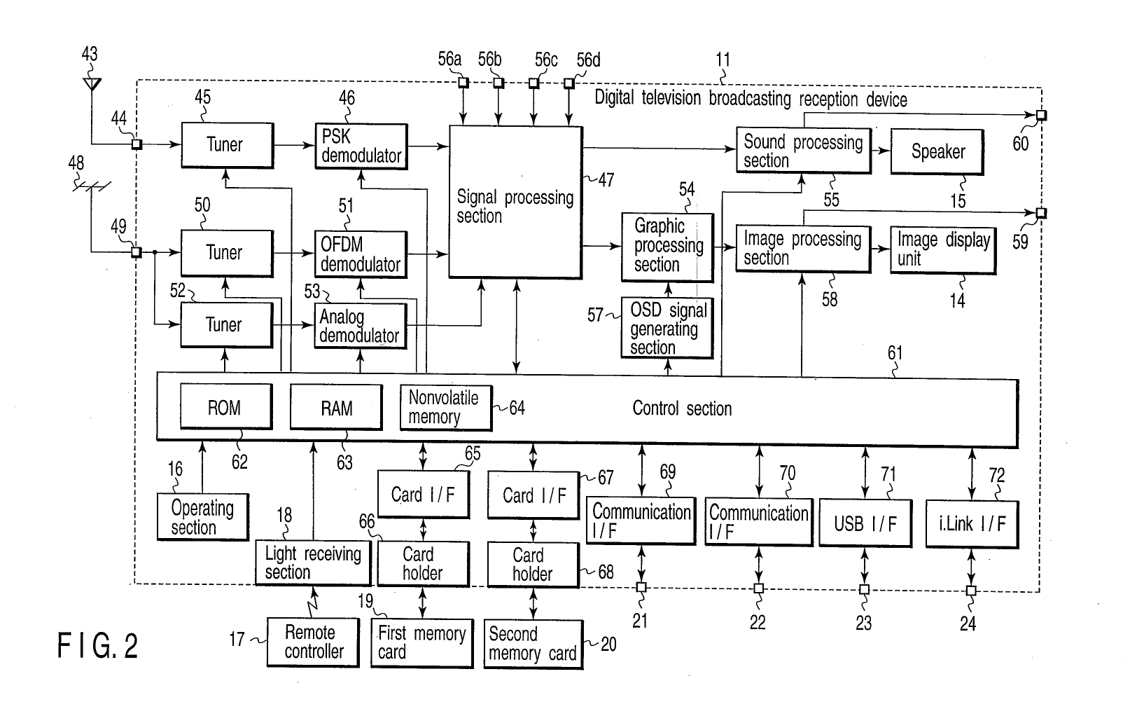

FIG. 2 shows a main signal processing system of the digital television broadcasting reception device 11. That is, a satellite digital television broadcasting signal received by an antenna 43 for reception of BS/CS digital broadcasting is supplied to a tuner 45 for satellite digital broadcasting via an input terminal 44, whereby a broadcasting signal of a desired channel is selected.

Then, the broadcasting signal selected by this tuner 45 is supplied to a phase shift keying (PSK) demodulator 46, demodulated into digital image and voice signals, and then output to a signal processing section 47.

In addition, a terrestrial digital television broadcasting signal received by an antenna 48 for receiving terrestrial broadcasting is supplied to a tuner 50 for terrestrial digital broadcasting via an input terminal 49, whereby the broadcasting signal of the desired channel is selected.

Then, the broadcasting signal selected by this tuner 50 is supplied to an orthogonal frequency division multiplexing (OFDM) demodulator 51, demodulated into digital image and voice signals, and then output to the signal processing section 47.

Furthermore, the terrestrial analog television broadcasting signal received by the antenna 48 for receiving the terrestrial broadcasting is supplied to a tuner 52 for terrestrial analog broadcasting via the input terminal 49, whereby the broadcasting signal of the desired channel is selected. Then, the broadcasting signal selected by this tuner 52 is supplied to an analog demodulator 53, demodulated into analog image and voice signals, and then output to the signal processing section 47.

Here, the signal processing section 47 selectively subjects, to predetermined digital signal processing, the digital image and voice signals supplied from the PSK demodulator 46 and the OFDM demodulator 51, respectively, and outputs the thus processed signals to a graphic processing section 54 and a voice processing section 55.

In addition, the signal processing section 47 is connected to a plurality of (four in the shown example) input terminals 56a, 56b, 56c and 56d. These input terminals 56a to 56d permit inputting the analog image and voice signals, respectively, from

outside the digital television broadcasting reception device 11.

Then, this signal processing section 47 selectively digitizes the analog image and voice signals supplied from the analog demodulator 53 and the input terminals 56a to 56d, respectively, subjects the digitized image and voice signals to predetermined digital signal processing, and then outputs the processed signals to the graphic processing section 54 and the voice processing section 55.

In these sections, the graphic processing section 54 has a function of superimposing an on-screen display (OSD) signal generated in an OSD signal generating section 57 on the digital image signal supplied from the signal processing section 47 to output the superimposed signal. This graphic processing section 54 can selectively output an output image signal of the signal processing section 47 and an output OSD signal of the OSD signal generating section 57, or combine and output both the outputs so as to constitute halves of a screen, respectively.

Then, the digital image signal output from the graphic processing section 54 is supplied to an image processing section 58. This image processing section 58 converts the input digital image signal into an analog image signal having such a format that the image can be displayed in the image display unit 14. Afterward, the converted signal is output to the image display unit 14 to display the image, and led to the outside via an output terminal 59.

In addition, the voice processing section 55 converts the input digital voice signal into an analog voice signal having such a format that can be reproduced at the speaker 15. Afterward, the converted signal is output to the speaker 15 to reproduce voice, and led to the outside via an output terminal 60.

Here, in this digital television broadcasting reception device 11, all operations, including the receiving operations described above are generically controlled by a control section 61. This control section 61 includes a central processing unit (CPU) and the like therein, and receives the operating information from the operating section 16 or the operating information sent from the remote controller 17 and received via the light receiving section 18 to control the respective sections so that operation contents of the information are reflected.

In this case, the control section 61 mainly utilizes a read only memory (ROM) 62 in which a control program to be executed by the CPU is stored, a random access memory (RAM) 63 which supplies an operation area to the CPU, and a nonvolatile memory 64 in which various types of setting information and control information are stored.

This control section 61 is connected, via a card interface (I/F) 65, to a card holder 66 to which the first memory card 19 can be attached. In consequence, the control section 61 can transmit information to the first memory card 19 attached to the card holder 66 via the card I/F 65.

Furthermore, the control section 61 is connected, via a card I/F 67, to a card holder 68 to which the second memory card 20 can be attached. In consequence, the control section 61 can transmit information to the second memory card 20 attached to the card holder 68 via the card I/F 67.

In addition, the control section 61 is connected to the first LAN terminal 21 via a communication I/F 69. In consequence, the control section 61 can transmit information, via the communication I/F 69, to the HDD 25 for the LAN connected to the first LAN terminal 21. In this case, the control section 61 has a dynamic host configuration protocol (DHCP) server function, and assigns an internet protocol (IP) address to the HDD 25 for the LAN connected to the first LAN terminal 21 to control the HDD 25.

Furthermore, the control section 61 is connected to the second LAN terminal 22 via a communication I/F 70. In consequence, the control section 61 can transmit the information, via the communication I/F 70, to the respective apparatuses (see FIG. 1) connected to the second LAN terminal 22.

Furthermore, the control section 61 is connected to the USB terminal 23 via a USB I/F 71. In consequence, the control section 61 can transmit the information, via the USB I/F 71, to the respective apparatuses (see FIG. 1) connected to the USB terminal 23.

Moreover, the control section 61 is connected to the i.Link terminal 24 via an i.Link I/F 72. In consequence, the control section 61 can transmit the information, via the i.Link I/F 72, to the respective apparatuses (see FIG. 1) connected to the i.Link terminal 24.

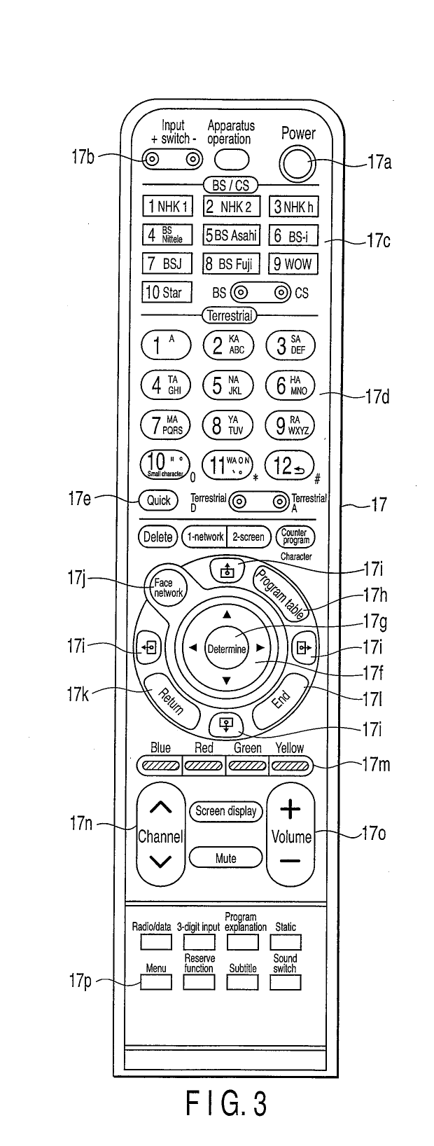

FIG. 3 shows an appearance of the remote controller 17. This remote controller 17 is mainly provided with a power supply key 17a, an input switch key 17b, direct channel selection keys 17c of satellite digital broadcasting channels, direct channel selection keys 17d of terrestrial broadcasting channels, a quick key 17e, a cursor key 17f, a determination key 17g, a program table key 17h, page switch keys 17i, a face network (navigation) key 17j, a return key 17k, an end key 171, blue, red, green and yellow color keys 17m, a channel up/down key 17n, a volume regulation key 17o, menu keys 17p and the like.

Here, in this digital television broadcasting reception device 11, when a user operates the program table key 17h of the remote controller 17, an electronic program table can be displayed in the image display unit 14.

This electronic program table is prepared based on EPG information, which is program information acquired beforehand via a broadcasting signal, a network and the like. In the case of television broadcasting, the whole program table for the next one week is prepared and displayed in the image display unit 14.

However, the whole prepared electronic program table for the one week is not collectively displayed in the image display unit 14 but a predetermined area including the predetermined number of the channels and a predetermined date region is displayed in the image display unit 14.

Moreover, the user can scroll the electronic program table on a screen of the image display unit 14 or switch an area of the electronic program table to be displayed for every screen unit of the image display unit 14 to visually recognize a desired area of the electronic program table.

It is to be noted that when the user operates the program table key 17h of the remote controller 17, the area of the electronic program table to be first displayed in the image display unit 14 is determined based on last conditions, such as a previously displayed channel and date.

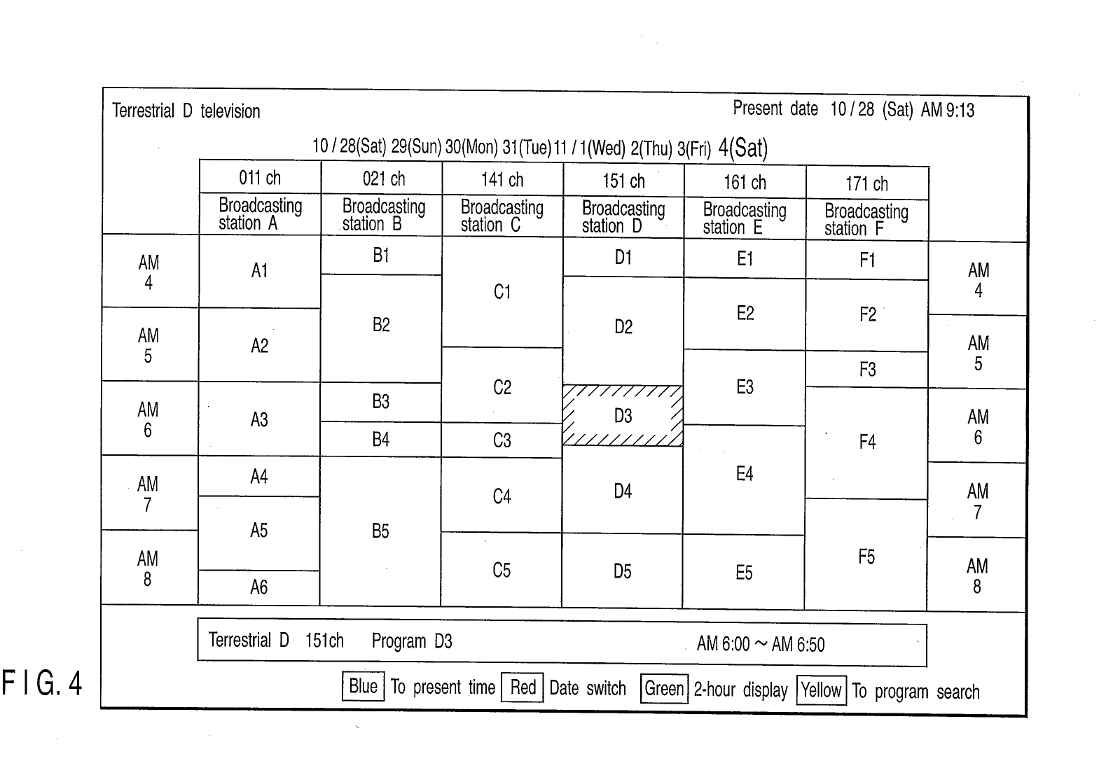

FIG. 4 shows one example of a display configuration of the electronic program table displayed in the image display unit 14. In this electronic program table, a horizontal direction is a channel axis along which a plurality of (six in the shown example) broadcasting stations (channels) are arranged, and a vertical direction is a time axis corresponding to a time region of several hours (five hours in the shown example), whereby programs are displayed.

That is, the center of this electronic program table has six program columns arranged corresponding to six broadcasting stations (channels) in the horizontal direction. In these six program columns, channel numbers 011, 021, 141, 151, 161 and 171, broadcasting station names A, B, C, D, E and F, and program names A1 to A6, B1 to B5, C1 to C5, D1 to D5, E1 to E5 and F1 to F5 are mentioned.

Moreover, an upper portion of this electronic program table in the drawing displays “terrestrial D television” indicating that a type of the presently received broadcasting is terrestrial digital television broadcasting. The upper portion also displays “present date 10/28 (Sat) AM 9:13” indicating that the present date is 9:13 a.m. on Saturday, October 28, and a region of days (days of the week) of the electronic program table which can be displayed.

That is, now, in the electronic program table, the present date is 9:13 a.m. on Saturday, October 28. Therefore, the table for one week from nine o'clock in the morning on October 28 (Saturday) to eight o'clock (before nine) in the morning on November 4 (Saturday) is prepared. Moreover, the region of the days (the days of the week) of the electronic program table which can be displayed includes days (days of the week) within one week from the present date (the day of the week). That is, eight days of October 28 (Saturday), 29 (Sunday), 30 (Monday), 31 (Tuesday), and November 1 (Wednesday), 2 (Thursday), 3 (Friday) and 4 (Saturday) are successively arranged and displayed. In this case, characters [4 (Sat)] indicating the day (day of the week) of the presently displayed electronic program table are larger than characters indicating the other days (days of the week).

A lower portion of this electronic program table in the drawing displays the type (terrestrial D) of broadcasting, channel number (151 ch), program name (D3), broadcasting time (AM 6:00 to AM 6:50) and the like of the presently selected program (indicated by a cursor in the electronic program table). In this case, the cursor indicates that a display area of the presently selected program D3 in the electronic program table is displayed with a color different from a color of a display area of another program. In FIG. 4, the area is surrounded by hatching.

In addition, this electronic program table includes left and right areas where a five-hour time region divided every hour unit is vertically displayed. In FIG. 4, programs in five hours of four, five, six, seven and eight o'clock in the morning are displayed downwards from the above.

A lower portion of this electronic program table in the drawing displays functions to be realized in correspondence with colors (blue, red, green and yellow) of the color keys 17m of the remote controller 17, when the color keys 17m are operated.

In this electronic program table, when the cursor key 17f of the remote controller 17 is operated, the table can selectively be scrolled in vertical and horizontal directions. When the page switch key 17i of the remote controller 17 is operated, the electronic program table can selectively be skipped as much as one screen unit in the vertical and horizontal directions.

In this case, when the electronic program table is scrolled and skipped in a time axis direction, the hours displayed on the left and right sides of the table and the program names displayed in six program columns are changed to moved hours and program names. When the table is scrolled and skipped in a channel axis direction, channel numbers, broadcasting station names and program names displayed in six program columns are changed to moved channel numbers, broadcasting station names and program names.

Here, now as shown in FIG. 4, in a state in which the program D3 to be broadcasted at 151 ch from six o'clock in the morning of 4 November is indicated with the cursor, the user operates the cursor key 17f of the remote controller 17 so as to move the cursor in a direction of the elapse of time (a downward direction in the drawing).

In this case, as described above, the electronic program table is prepared up to only eight o'clock (before nine o'clock) in the morning of 4 November (Saturday). That is, a table after nine o'clock in the morning of 4 November (Saturday) is not prepared, because there is no program information.

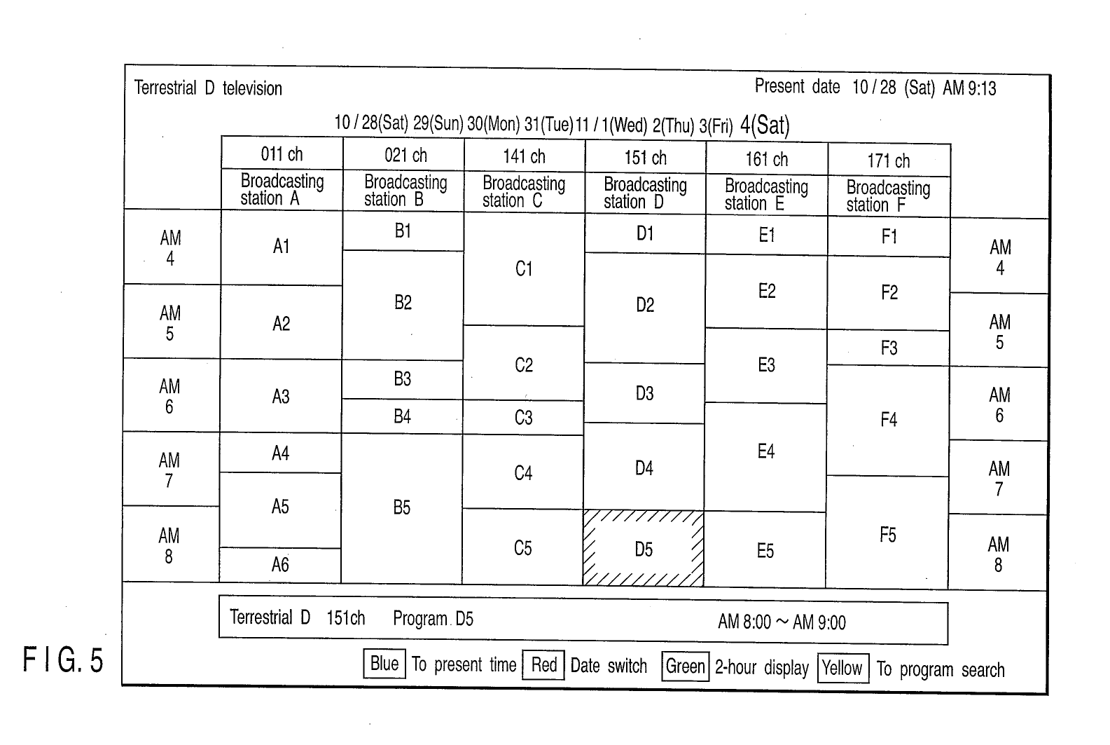

Therefore, as shown in FIG. 5, it is assumed that a program D5 to be broadcasted on the same channel (151 ch) at eight o'clock in the morning (i.e., a program which does not have any program of the subsequent date to be displayed in the electronic program table) is indicated with a cursor and that the cursor key 17f of the remote controller 17 is operated so as to display even programs after nine o'clock in the morning.

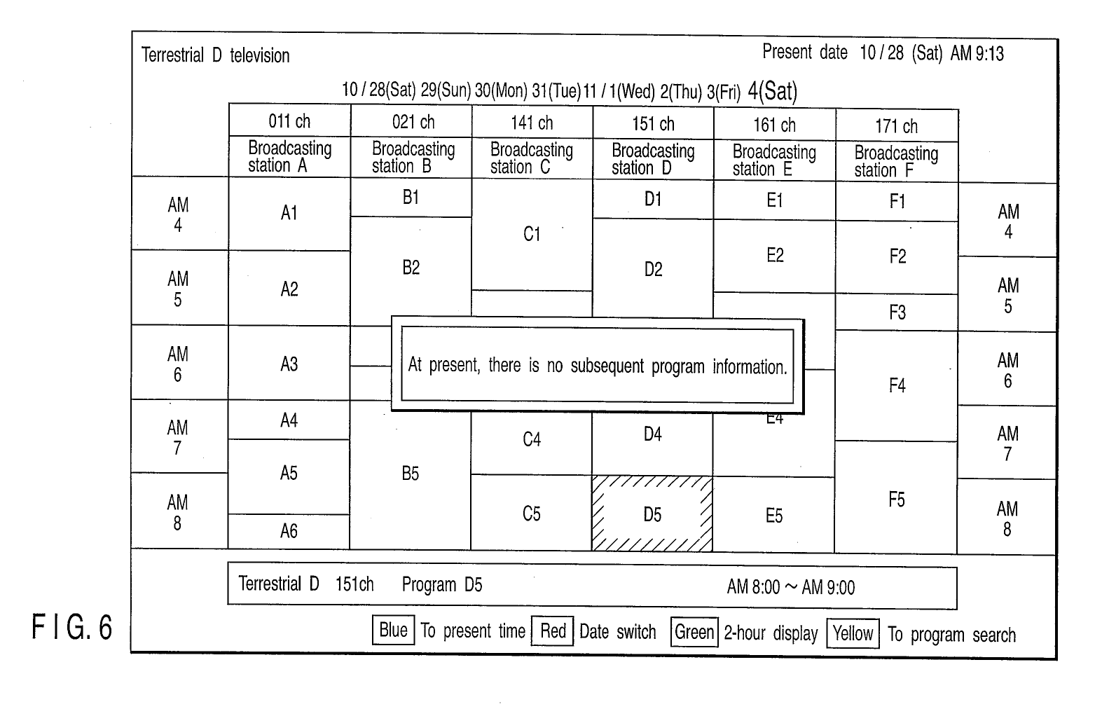

In this case, the electronic program table does not scroll. As shown in FIG. 6, at the center of the electronic program table, a message “at present, there is no subsequent program information” is automatically displayed. In consequence, the user can quickly recognize that the electronic program table is not displayed.

In this respect, under the present situation, when movement of the cursor to an area where no electronic program table is prepared is requested, the scroll of the electronic program table is simply stopped. Therefore, the user cannot understand the reason why the table is not scrolled, and sometimes operates the cursor key many times or judges that the table has a failure.

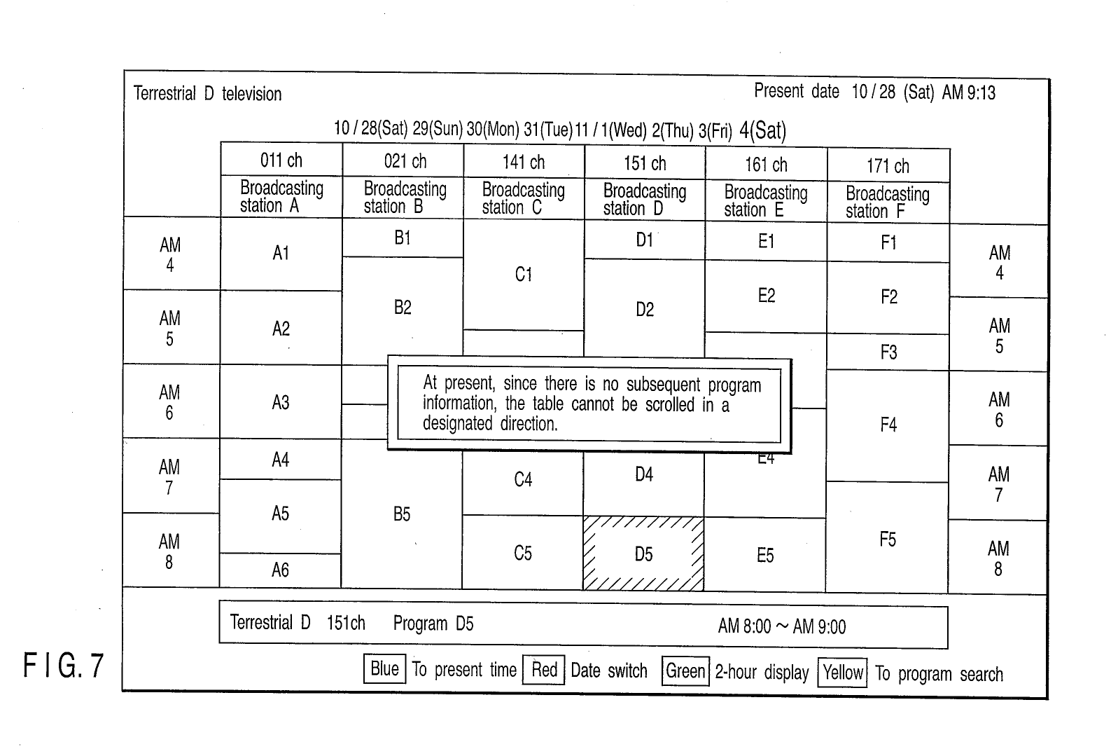

It is to be noted that when display of a region in excess of the acquired program information is requested, as shown in FIG. 7, a message “at present, since there is no subsequent program information, the table cannot be scrolled in a designated direction” indicating that the electronic program table is not scrolled or that the page is not switched may be notified to the user.

In addition, as shown in FIG. 4, it is assumed that the user operates the page switch key 17i of the remote controller 17 so as to display the programs after nine o'clock in the morning in a state in which the program D3 is indicated with the cursor.

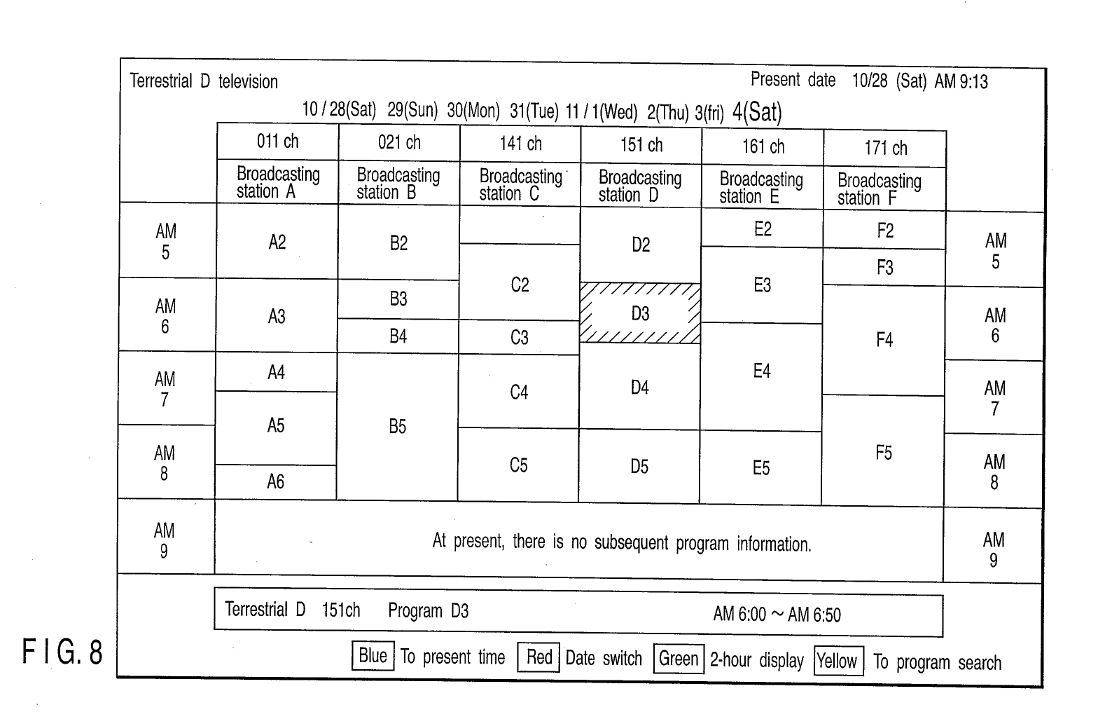

In this case, as shown in FIG. 8, nine o'clock in the morning is displayed at the lowermost display areas of the left and right time display areas of the electronic program table, and a message “at present, there is no subsequent program information” can be displayed using six program columns corresponding to the display areas in common.

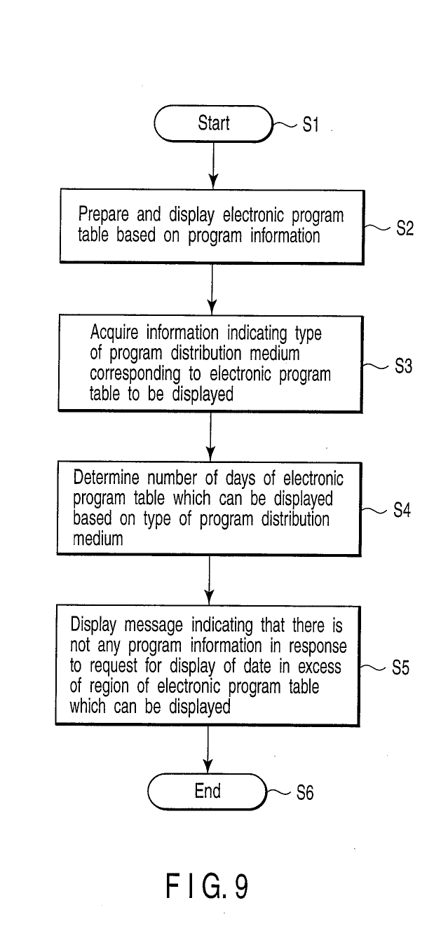

FIG. 9 shows a flow chart of an integrated processing operation of notifying a message to the user, in a case where the display of the region in excess of the acquired program information is requested. That is, when the operation is started (step S1), in step S2, the control section 61 prepares and displays the electronic program table based on the program information acquired via a broadcasting signal, a network and the like.

Afterward, in step S3, the control section 61 acquires information indicating a type (television broadcasting, radio broadcasting, etc.) of a program distribution medium corresponding to the electronic program table to be displayed based on the previously acquired program information. In step S4, the control section determines the number of the days which can be displayed in the electronic program table based on the type of the program distribution medium.

Moreover, in a case where display of the date in excess of the region of the electronic program table provided based on the previously acquired program information is requested in step S5, the control section 61 displays a message indicating that there is no program information in the requested portion, thereby ending the processing (step S6).

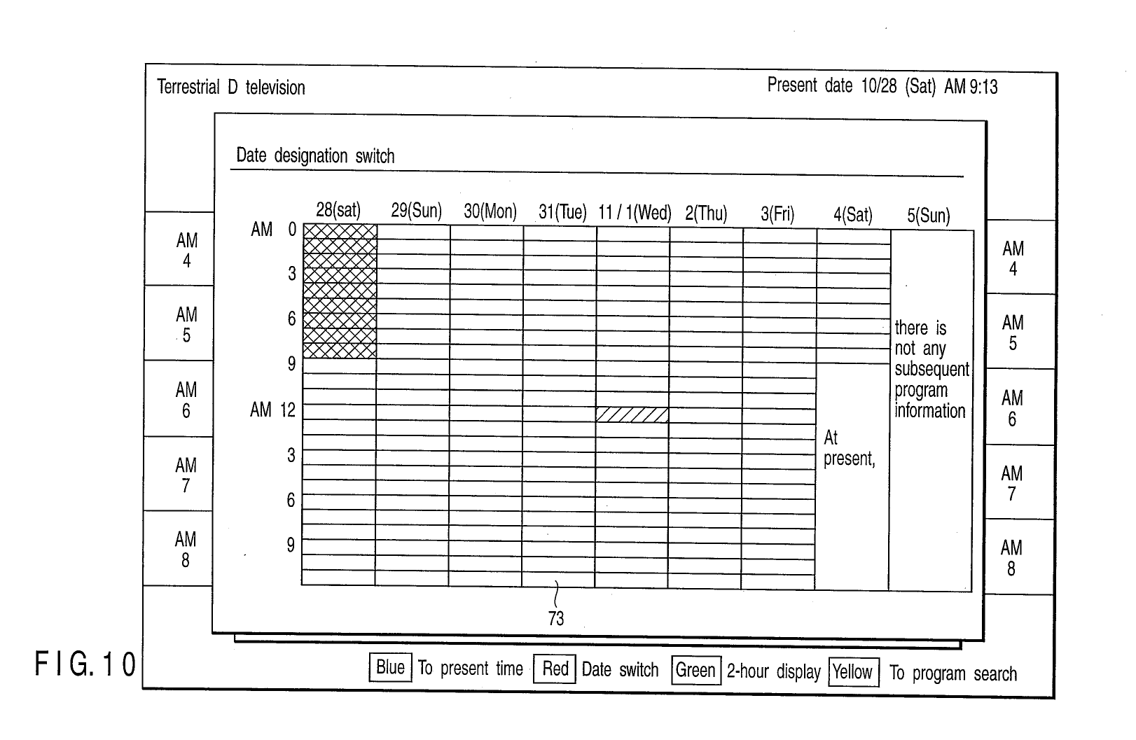

Furthermore, as shown in FIG. 4, in a case where the user operates the red color key 17m of the remote controller 17 in a state in which the program D3 is indicated with the cursor, a date designation switch screen is displayed so as to be superimposed on the electronic program table as shown in FIG. 10.

In this date designation switch screen, a date region is specified based on a date axis along which nine days (28 October to 5 November) including the present date are arranged in units of days in the horizontal direction and a time axis along which 24 hours (zero to eleven o'clock in the morning) are arranged in units of hours in the vertical direction. Moreover, in this date designation switch screen, a region indicating the specific date region formed along the date axis and the time axis for eight days (October 28 to November 4) including the present day is divided by the day unit and the hour unit. In consequence, a unit designation area 73 of 8 days×24 hours=192 units is prepared.

In addition, at this date designation switch screen, the user operates the cursor key 17f of the remote controller 17 to select the predetermined unit designation area 73, and operates the determination key 17g. In consequence, the electronic program table including the dates corresponding to the unit designation area 73 at the center thereof can be displayed. In this case, the selected unit designation area 73 is displayed in a different color from that of another area, but in FIG. 10, the area is represented by hatching.

As shown in, for example, FIG. 4, it is assumed that the date designation switch screen is displayed in a state in which the channel number is 151 ch and the program D3 from six o'clock in the morning is indicated with the cursor, and the unit designation area 73 at noon on 1 November is selected and determined. In consequence, the electronic program table is displayed in which the program column of the same channel 151 ch on 1 November (Thursday) is substantially arranged at the center of the screen and six o'clock in the morning is substantially arranged at the center of the screen. The date can be designated to switch and display the electronic program table.

Here, in the date designation switch screen, needless to say, a date region where the program information can be acquired (the electronic program table is prepared), that is, the unit designation area 73 of the region for one week from the present date can be selected. Specifically, as in the electronic program table shown in FIG. 4, when the screen is switched to the date designation switch screen on the present date, that is, 9:13 a.m. of 28 October (Saturday), as shown in FIG. 10, dates of eight days including the present time and arranged in the horizontal direction are 28 October (Saturday) to 4 November (Saturday). The dates of this region can be selected by the unit of the unit designation area 73.

However, in the unit designation area 73 of an already past time zone, that is, an area before nine o'clock in the morning of 28 October in FIG. 10, even when the cursor key 17f of the remote controller 17 is operated, the unit designation area 73 is not selected. In this case, the selectable unit designation area 73 and the non-selectable unit designation area 73 are displayed in changed colors, but in FIG. 10, the non-selectable unit designation area 73 is displayed by hatching.

Moreover, even in the date region in which no program information is acquired and the electronic program table is not prepared yet, that is, the area after nine in the morning of 4 November, even when the cursor key 17f of the remote controller 17 is operated, the unit designation area 73 is not selected. In this case, in the area after nine in the morning of 4 November, a message “at present, there is no subsequent program information” is displayed together with an area of the next date, that is, 5 November. Therefore, the user can recognize beforehand that no electronic program table is prepared after nine o'clock in the morning of 4 November.

Here, in the above-mentioned embodiment, in a case where display of the electronic program table indicating the date on which no program information is acquired is requested, a message indicating that no program information is acquired is displayed to notify the user, but the present invention is not limited to the display of the message, and a warning message such as error sound or voice guidance may be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program table display device comprising:
an acquiring section configured to acquire program information;
a preparing section configured to prepare an electronic program table based on the program information acquired by the acquiring section;
a display section configured to display the electronic program table prepared by the preparing section so that the table moves on a screen;
a detecting section configured to detect that the electronic program table displayed in the display section is requested to be moved to display, on the screen, a portion corresponding to a date on which no program information is distributed; and
a notifying section configured to notify that no program information is present based on a detection result of the detecting section.

2. A program table display device according to claim 1, wherein the notifying section is configured to notify that the electronic program table displayed in the display section is not moved to an area corresponding to the requested date.

3. A program table display device according to claim 1, wherein the notifying section is configured to perform the notification by one of an image and a voice.

4. A program table display device according to claim 1, wherein the display section is configured to determine a date region of the electronic program table prepared in the preparing section based on the program information acquired by the acquiring section to perform the detection based on the determined date region and the requested date.

5. A program table display device according to claim 1, further comprising:
a designated screen display section configured to divide, by a date unit and a predetermined time unit, a face formed based on the program information acquired by the acquiring section and indicating a specific date region including a date axis and a time axis, thereby displaying a date designation switch screen in which a plurality of unit designation areas are arranged;
a selecting section configured to select a predetermined unit designation area on the date designation switch screen displayed in the designated screen display section;
a display control section configured to display, on the screen, a portion of the electronic program table corresponding to a date designated in the unit designation area selected in the selecting section; and
a notification display section configured to indicate that no program information is present at a portion corresponding to a date on which no program information is distributed, in areas of the date designation switch screen divided by a date unit.

6. A broadcasting reception device comprising:
a receiving section configured to receive a broadcasting signal;
a signal processing section configured to extract a signal of a desired channel from the broadcasting signal received by the receiving section, and to subject the signal to predetermined signal processing to generate an image signal;
an output section configured to output the image signal obtained by the signal processing section;
an acquiring section configured to acquire program information;
a preparing section configured to prepare an electronic program table based on the program information acquired by the acquiring section;
a display section configured to display the electronic program table prepared by the preparing section so that the table moves on a screen;
a detecting section configured to detect that the electronic program table displayed in the display section is requested to be moved to display, on the screen, a portion corresponding to a date on which no program information is distributed; and
a notifying section configured to notify that no program information is present based on a detection result of the detecting section.

7. A program table display method comprising:
acquiring program information;
preparing an electronic program table based on the acquired program information;
displaying the prepared electronic program table so that the table moves on a screen;
detecting that the displayed electronic program table is requested to be moved to display, on the screen, a portion corresponding to a date on which no program information is distributed; and
notifying that no program information is present based on a detection result of the detecting section.
